(19) United States
(12) Patent Application Publication
(10) Pub. No.: US 2003/0044576 A1
(43) Pub. Date: Mar. 6, 2003

(54) Method and apparatus for an encased optical article

(76) Inventors: Lisa Dhar, New Providence, NJ (US); Melinda Schnoes, Longmont, CO (US); Gayle Schomberger, Broomfield, CO (US); Songvit Setthachayanon, Longmont, CO (US); Kevin Curtis, Longmont, CO (US)

Correspondence Address: MORRISON & FOERSTER LLP, 425 MARKET STREET, SAN FRANCISCO, CA, 94105-2482, US

(21) Appl. No.: 09/935,462

(22) Filed: Aug. 22, 2001

(51) Int. Cl. B32B 3/02; B32B 3/10

(52) U.S. Cl. 428/137; 428/64.1; 428/66.6; 428/80; 156/245

(57) ABSTRACT

The present invention provides a solution to the needs described above through method and apparatus for an encased optical article. The outer surface of a first substrate is grasp with a first holder, whereby the outer surface of the first substrate is held to an inner surface of the first holder. The outer surface of a second substrate is grasp with a second holder, whereby the outer surface of the second substrate is held to an inner surface of the second holder. The inner surfaces of the first and second holders are arranged to face one another in a selected angular relationship, and an optical article is inserted between the first and second substrate, wherein a first layer of adherent is between a first surface of the optical article and the inner surface of the first substrate, and a second layer of adherent is between a second surface of the optical article and the inner surface of the second substrate. The first and second holders are moved toward each other such that the inner surfaces of the first and second substrates contact the first and second layer of adherent with the optical article in between the first and second layer of adherent. The adherent is the at least partially cured while the inner surfaces of the first and second holders are in the selected angular relationship to form a multilayer article encasing the optical article. After removal of the first and second holder, the at least partially cured adherent maintains the multilayer article containing the optical article in the posture at which the multilayer article was held by the first and second holders.

### TECHNICAL FIELD

The present invention relates to the general field of optical articles. More specifically the invention relates to forming multilayer optical articles with improved optical properties.

### BACKGROUND

Many optical systems require devices having specific optical properties, in particular, surface flatness, thickness uniformity, and/or bow. Surface flatness of an article is determined by measuring the variation of the article's surface from a specified surface profile (the profile, for example, may have a certain bow). The thickness uniformity is measured by the article's variation from a specified thickness or profile (e.g., parallel or wedge-shaped). Both of these parameters are typically measured in units of optical waves of variation from the specified profile per transverse distance, e.g., waves/cm, where the wave is a specified wavelength, e.g., of the particular light being used for measurement or for the ultimate use. When used herein, units of waves/cm indicate an average measurement over the area of the article intended to have the desired optical characteristics. Bow is a physical measurement, determined as shown by FIG. 1. The distance B from the center of an article to a line drawn between two contact points where a plane meets the article is divided by half of the distance Y of that line. The units (e.g., B cm/(Y/2) cm) divide out to give a unitless value.

For optics applications, where one is concerned with the effect of an article on light passing through that article, physical thickness uniformity is typically not relied upon. Instead, a transmission flatness is determined by measuring the deviation of the optical path length (discussed below) from the preselected profile, and FIG. 2 shows this measurement for a configuration desired to have a uniform thickness (i.e., parallel surfaces). Transmission flatness is also presented in waves/cm, and, as known to those in the art, transmission flatness may also be expressed in rms (root mean squared) waves/cm or by the Strehl value, as discussed in J. W. Goodman, Introduction to Fourier Optics, McGraw-Hill, 1968. FIG. 2 shows two paths through a multilayer article, the paths located a distance z from each other transversely across the article. The physical path length difference across distance z is |1′-1|, and the variation from exact thickness uniformity is |1′-1|/z, which is typically measured in micrometers/cm. The physical path length is not affected by, nor does it take into account, the refractive indices of the individual layers 10, 12, and 14, or the wavelength of the light being used.

Optical path length (OPL) is the relevant parameter for transmission flatness and is represented by the following formula:

$$OPL = {\sum }_{j} njLj ,$$

where

n|j| is the refractive index of layer j and

L|j| is the physical path length through layer j.

In contrast to physical path length, the OPL depends on the refractive index. For example, in a multilayer article such as that of FIG. 2, the OPL depends on the refractive indices of layers 10, 12, and 14. Specifically, the OPL difference (delta OPL) across the article of FIG. 2 is equal to:

|(n10L10+n12L12+n14L14)−(n10L′10+n12L′12+n14L′14)|

This equation shows that where the goal is a small OPL difference, if the substrates have relatively large individual thickness variations, but the overall thickness variation is relatively small, it is useful for the refractive indices of the substrates to be close. As reflected in FIG. 2, the transmission flatness, assuming a parallel configuration is desired, is therefore delta OPL/z. For optics applications, it is clear that the variation from a selected profile in OPL is more meaningful than the change in physical path length per transverse unit.

Transmission and surface flatness values are presented in waves/cm, where the value given is for a specified wavelength. Use of such waves/cm herein indicates that the value is for the optical path length as opposed to the physical path length. For purposes of the present application, values in waves/cm are useful at least for wavelengths ranging from about 0.3 to about 0.9 micrometers, but the concept of the invention extends beyond this range.

For substrates typically used in optics applications, there are three basic types of thickness variations that affect surface and transmission flatness. The first type is a linear thickness change from low to high over the surface of the substrate, whereby the substrate essentially takes the form of a wedge. The thickness variation of such a substrate per unit length is relatively constant. The second type of a variation is a gradual, wavy, or random, variation, where the thickness varies, for example, from low to high to low to high gradually across the width of the substrate. The thickness variation of such a substrate per unit length is relatively constant, but the substrate does not take the form of a wedge. The third type of variation is localized, sharp divots or peaks. Such divots or peaks typically cause rapid variations in thickness measurements taken at different locations along a substrate and may therefore skew an rms measurement. Structures having this third type of variation are typically measured in terms of scratch and dig, as known in the art. Clearly, these characteristics often cause numerous difficulties when attempting to form structures with combinations of low surface smoothness variations, low thickness uniformity variations, and/or low bow.

Articles used in precise applications desirably have a surface and transmission flatness of 0.1 waves/cm or better. Articles for transmission applications where parallel surfaces are desired desirably have a bow of 10⁻² or less (less meaning numerically smaller), and articles for reflection applications where parallel surfaces are desired desirably have a bow of 10⁻⁵ or less. It is difficult to prepare or obtain substrates or multilayer articles having such properties. High quality glass intended for flat panel displays (referred to herein as display glass), for example, will have surface and transmission flatness values ranging from about 0.25 to about 4 waves/cm. To obtain better, and more consistent flatness values, it is necessary to obtain a thick piece of glass and polish the glass to a desired flatness. Such chemical/mechanical polishing, however, is expensive and time-consuming, and may still be inadequate for preparing substrates and articles having the above properties. Easier and less expensive methods for improving the optical flatness of substrates and for forming optical articles, e.g., articles, having certain bow, thickness uniformity, and surface flatness, are desired, particularly for optical articles which have already been previously formed with inadequate surface flatness, thickness uniformity, or bow.

### SUMMARY OF THE INVENTION

The present invention provides a solution to the needs described above through a method and apparatus for a multilayer optical article. In an embodiment of the invention, the outer surface of a first substrate is grasped with a first holder, whereby the outer surface of the first substrate is held to an inner surface of the first holder. The outer surface of a second substrate is grasped with a second holder, whereby the outer surface of the second substrate is held to an inner surface of the second holder. The inner surfaces of the first and second holders are arranged to face one another in a selected angular relationship, and an optical article is inserted between the first and second substrate, wherein a first layer of adherent is between a first surface of the optical article and the inner surface of the first substrate, and a second layer of adherent is between a second surface of the optical article and the inner surface of the second substrate. The first and second holders are moved toward each other such that the inner surfaces of the first and second substrates contact the first and second layer of adherent with the optical article in between the first and second layer of adherent. The adherent is then at least partially cured while the inner surfaces of the first and second holders are in the selected angular relationship to form a multilayer article encasing the optical article. After removal of the first and second holder, the at least partially cured adherent maintains the multilayer article containing the optical article in the posture at which the multilayer article was held by the first and second holders.

In a further embodiment of the invention, a multilayer optical article is formed by first grasping an outer surface of a substrate with a first holder, whereby the outer surface of the substrate is held to an inner surface of the first holder. The inner surfaces of a second holder and the first holder are arranged to face one another in a selected angular relationship. An optical article is inserted between the substrate and the second holder, wherein a first layer of adherent is between a first surface of the optical article and the inner surface of the substrate, and a second layer of adherent is between a second surface of the optical article and the inner surface of the second holder. The first and second holders are moved toward each other such that the inner surfaces of the substrate and second holder contact the first and second layer of adherent with the optical article in between the first and second layer of adherent. The adherent is at least partially cured while the inner surfaces of the first and second holders are in the selected angular relationship to form a multilayer article encasing the optical article. After removal of the first and second holder, the at least partially cured adherent maintains the multilayer article containing the optical article in the posture at which the multilayer article was held by the first and second holders.

In a further embodiment of the invention, a multilayer optical article is formed by first disposing an adherent on an inner surface of a first holder. An optical article is then inserted on the adherent. A second adherent is then disposed on the inserted optical article. The first holder is moved toward a second holder such that the second holder contacts the second adherent with the optical article in between the first and second layer of adherent. The adherent is at least partially cured while the inner surfaces of the first and second holders are in a selected angular relationship to form a multilayer article encasing the optical article. After removal of the first and second holder, the at least partially cured adherent maintains the multilayer article containing the optical article in the posture at which the multilayer article was held by the first and second holders.

A multilayer article in an embodiment of the invention comprises a first substrate, a second substrate, and an article located between the first substrate and the second substrate. A first layer of partially cured adherent is disposed between the first substrate and the article and a second layer of partially cured adherent is disposed between the second substrate and the article. A multilayer article in another embodiment of the invention comprises a substrate, an article, a first layer of at least partially cured adherent between the substrate and a first surface of the article, and a second layer of at least partially cured adherent disposed on a second surface of the article.

A multilayer article in another embodiment of the invention comprises an article with a first layer of at least partially cured adherent on a first surface of the article and a second layer of at least partially cured adherent disposed on a second surface of the article. The multilayer article has a surface flatness of about 0.05 waves/cm to about 1 wave/cm at wavelengths of about 300 nanometers to 1600 nanometers and a transmission flatness of about 0.05 waves/cm to about 1 wave/cm at wavelengths of about 300 nanometers to 1600 nanometers.

Still other embodiments of the present invention will become apparent to those skilled in the art from the following detailed description, wherein is shown and described only the embodiments of the invention by way of illustration of the best modes contemplated for carrying out the invention. As will be realized, the invention is capable of modification in various obvious aspects, all without departing from the spirit and scope of the present invention. Accordingly, the drawings and detailed description are to be regarded as illustrative in nature and not restrictive.

### DESCRIPTION OF THE DRAWINGS

The features and advantages of the system and method of the present invention will be apparent from the following description in which:

FIG. 1 illustrates bow in an article.

FIG. 2 illustrates physical and optical path length through a multilayer article.

FIG. 3a shows the inner surface of a holder of one embodiment of the invention.

FIG. 3b shows a cross-sectional side view, along line a-a′, of the holder of FIG. 3a.

FIG. 4a shows the inner surface of a holder of another embodiment of the invention.

FIG. 4b shows a cross-sectional side view, along line b-b′, of the holder of FIG. 4a.

FIG. 5 shows a step in one embodiment of the method of the invention.

FIGS. 6a-e show steps in a further embodiment of the method of the invention.

FIGS. 7 and 8 illustrate the forces required to maintain the optical characteristics of articles made according to the invention.

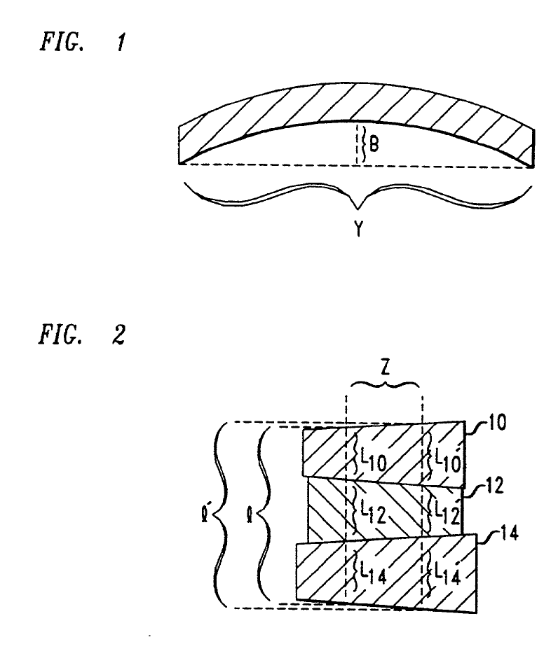

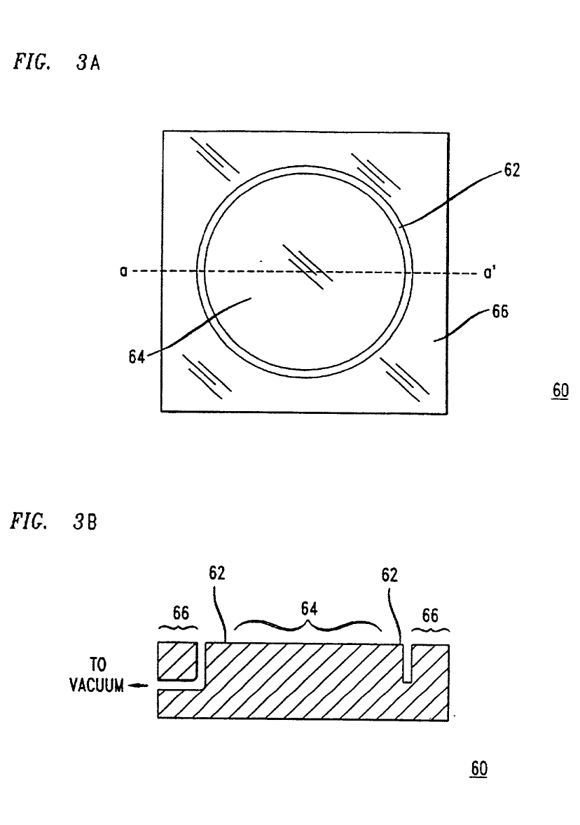

### DETAILED DESCRIPTION

The invention relates to a method for fabricating multilayer optical articles containing a previously formed optical article. The outer surface of a first substrate is grasp with a first holder, whereby the outer surface of the first substrate is held to an inner surface of the first holder. The outer surface of a second substrate is grasp with a second holder, whereby the outer surface of the second substrate is held to an inner surface of the second holder. The inner surfaces of the first and second holders are arranged to face one another in a selected angular relationship, and an optical article is inserted between the first and second substrate, wherein a first layer of adherent is between a first surface of the optical article and the inner surface of the first substrate, and a second layer of adherent is between a second surface of the optical article and the inner surface of the second substrate. The first and second holders are moved toward each other such that the inner surfaces of the first and second substrates contact the first and second layer of adherent with the optical article in between the first and second layer of adherent. The adherent is the at least partially cured while the inner surfaces of the first and second holders are in the selected angular relationship to form a multilayer article encasing the optical article. After removal of the first and second holder, the at least partially cured adherent maintains the multilayer article containing the optical article in the posture at which the multilayer article was held by the first and second holders.

In a further embodiment of the invention, a multilayer optical article is formed by first grasping an outer surface of a substrate with a first holder, whereby the outer surface of the substrate is held to an inner surface of the first holder. The inner surfaces of a second holder and the first holder are arranged to face one another in a selected angular relationship. An optical article is inserted between the substrate and the second holder, wherein a first layer of adherent is between a first surface of the optical article and the inner surface of the substrate, and a second layer of adherent is between a second surface of the optical article and the inner surface of the second holder. The first and second holders are moved toward each other such that the inner surfaces of the substrate and second holder contact the first and second layer of adherent with the optical article in between the first and second layer of adherent. The adherent is at least partially cured while the inner surfaces of the first and second holders are in the selected angular relationship to form a multilayer article encasing the optical article. After removal of the first and second holder, the at least partially cured adherent maintains the multilayer article containing the optical article in the posture at which the multilayer article was held by the first and second holders.

In a further embodiment of the invention, a multilayer optical article is formed by first disposing an adherent on an inner surface of a first holder. An optical article is then inserted on the adherent. A second adherent is then disposed on the inserted optical article. The first holder is moved toward a second holder such that the second holder contacts the second adherent with the optical article in between the first and second layer of adherent. The adherent is at least partially cured while the inner surfaces of the first and second holders are in a selected angular relationship to form a multilayer article encasing the optical article. After removal of the first and second holder, the at least partially cured adherent maintains the multilayer article containing the optical article in the posture at which the multilayer article was held by the first and second holders.

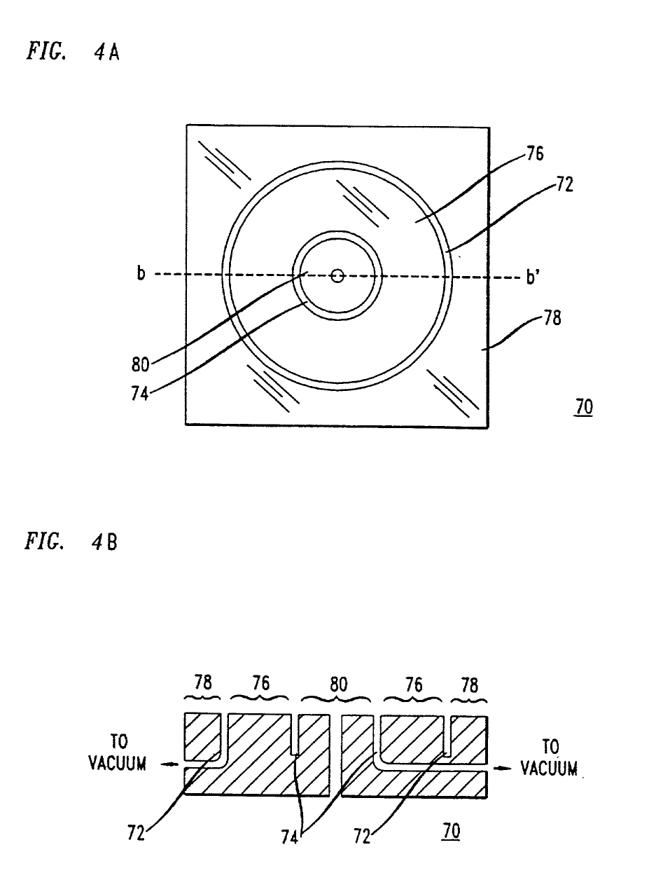

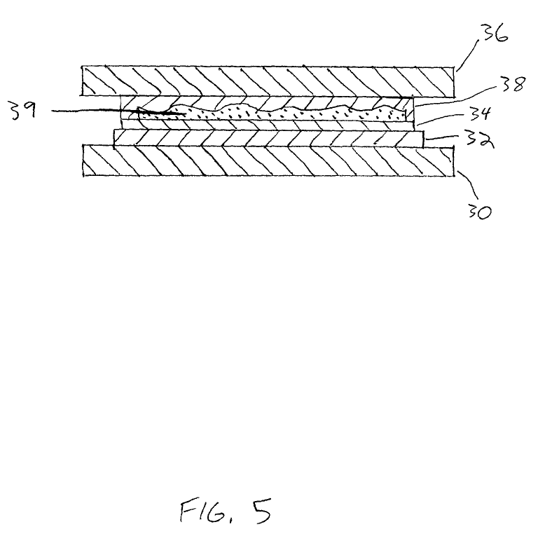

To maintain the surface flatness, transmission flatness, and/or bow, the inner surface of the holder or holders must comprise a continuous surface portion to which at least a portion of the substrate substantially conforms. As used herein, the term holder is intended to define an article comprising, among other things, such a continuous surface portion. The continuous surface portion does not have a discontinuity that would allow for non-conformance of the substrate. (It is possible for the continuous surface portion to have relatively small discontinuities, e.g., small holes, as long as the discontinuities do not allow for such non-conformance.) It is possible for the continuous surface portion to be bounded by an area where a grasping force is applied, e.g., a vacuum groove (such as in FIGS. 3a and 3b), or for the grasping force to be applied at more than one area around and/or within the continuous surface portion, e.g., several vacuum grooves (such as in FIGS. 4a and 4b) or several vacuum holes. It is also possible for the grasping force to be applied through the entire continuous surface portion, e.g., by an electromagnetic material. It is over this continuous surface portion that the flatness and/or bow is maintained. The vacuum groove or vacuum holes may be used to inject air when the vacuum is released in order to release the formed multilayer optical article.

FIGS. 3a and 3b show a holder 60 suitable for use in the invention that contains such a continuous surface portion. (FIG. 3b is a cross-sectional side view along line a-a′ of FIG. 3a.) The holder 60 contains a single vacuum groove 62 that is attached to a vacuum (not shown). The vacuum groove 62 bounds a continuous surface 64 to which a substrate will substantially conform upon application of the vacuum. Surface 66 of the holder 60 is outside the vacuum groove 62, and is not part of a continuous surface portion. A substrate would not be forced to substantially comply with the surface 66 upon application of a vacuum.

FIGS. 4a and 4b show another holder 70 suitable for use in the invention. (FIG. 4b is a cross-sectional side view along line b-b′ of FIG. 4a.) The holder 70 contains two vacuum grooves-an outer vacuum groove 72 and an inner vacuum groove 74. A continuous surface 76 lies between groove 72 and groove 74. Surface 78 (lying outside the outer vacuum groove 72) is not part of a continuous surface portion. Also, as shown in FIGS. 4a and 4b, it is possible for holder 70 to have a hole located at the area of surface 80, in which case surface 80 is also not part of a continuous surface portion.

In a case where the holder uses electromagnetic force to grasp a substrate, it is possible for the continuous surface portion to apply-the force over its entirety, or for the continuous surface portion to have a particular area around its periphery, e.g., in the shape of a ring or a square, in which the force is applied. In the latter embodiment, the posture of the substrate will be maintained over and within the ring or square in which the force is applied.

In contrast to the holder embodiments above, a vacuum ring does not constitute a holder in accordance with the invention, because the vacuum groove of the ring does not bound a continuous surface portion-the gap in the middle of the ring provides a discontinuity that allows non-conformance of a substrate.

The inner surfaces of the holders of the invention have an optically desirable shape and/or surface. Advantageously, the inner surface of a holder has a surface flatness of about 0.05 to about 0.25 waves/cm. The inner surface of a holder may also have a surface flatness greater than this range, depending on the required surface flatness of the multilayer article. For example, the inner surface of the holder may have a surface flatness of about 1.0 waves/cm. Also advantageously, the inner surface of a holder has a bow of about 10⁻² or better, particularly for articles intended for transmission applications, whereas a bow of about 10⁻⁵ or better is advantageous for articles intended for reflective applications. It is possible for the steps of these embodiments to be performed in an order other than the order presented above.

Advantageously, the multilayer articles of the invention have surface flatness and transmission flatness values of about 0.05 to about 0.25 waves/cm, these numbers useful for at least wavelengths of about 0.3 to about 0.9 micrometers, although the concept of the invention extends beyond this range. For example, the surface flatness and transmission flatness values may be about 1.0 waves/cm. Also advantageously, particularly where two substrates are used, the articles have a bow of about 10⁻² or less, and more advantageously, about 10⁻⁵ or less (particularly for reflective applications).

It is advantageous for the selected angular relationship between the inner surfaces of the holders to be a parallel relationship, meaning that the distance between the continuous surface portions of the inner surfaces of the two holders (optionally the whole of the inner surfaces) does not vary by more than about 1 wave/cm. A multilayer article having parallel substrates advantageously has surface flatness and transmission flatness values of about 0.05 to about 0.25 waves/cm, a Strehl value of 0.5 or greater (more advantageously 0.9 or greater) and a bow of about 10⁻² or less (advantageously 10⁻⁵ or less for reflective applications).

The adherent is advantageously disposed in a continuous layer. The improved flatness and/or bow of the substrate or multilayer article is primarily attained in the area where the adherent contacts a substrate or substrates. The area of the adherent is typically within the area of the continuous surface portion of the holder or holders. Portions of the substrate or substrates that extend past the area of the adherent, and especially past the area of the continuous surface portion tend to return to their initial state after the holder or holders are removed. When flatness, Strehl value, and bow of a substrate or an article are discussed herein, the flatness, Strehl value, or bow referred to is of this area where the adherent maintains the flatness and/or bow of a substrate or the flatness and/or bow of a multilayer article.

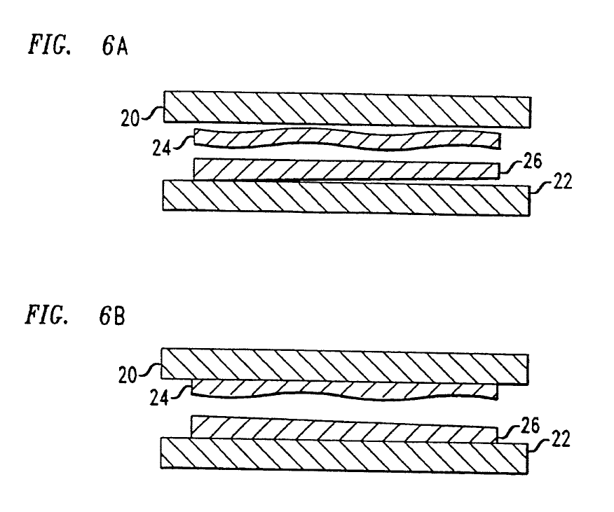

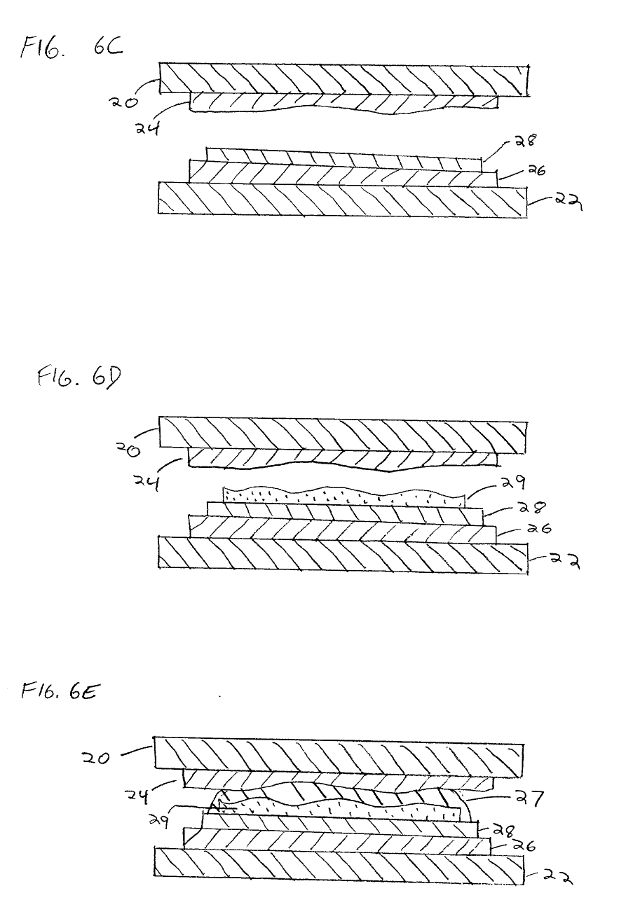

In accordance with an embodiment of the invention utilizing two substrates, as shown in FIGS. 6a-6e, two holders 20, 22 having inner surfaces with relatively low bow are brought into a selected angular relationship (in this embodiment, a parallel relationship). For simplicity, the continuous surface portions of the inner surfaces of holders 20, 22 are not shown. It is possible, for example, for holder 20, 22 to have the configuration of FIGS. 3a and 3b or FIGS. 4a and 4b. In this embodiment, the two holders 20, 22 are arranged to allow them to be manipulated into a parallel relationship and moved toward each other. For example, it is possible for holder 22 to be attached to gimbals that rotate in pitch and yaw (i.e., about its x- and y-axes), and holder 20 to be attached to an apparatus above holder 22 such that holder 20 is fixed in the pitch-yaw (i.e., x-y) plane but is capable of movement along the z-axis. It is possible to use a Fizeau interferometric method, such. as discussed in E. Hecht, Optics, Addison-Wesley Publishing, 1987, or a similar method known in the art, to measure the parallelism of the inner surfaces of the holders 20, 22 and allow for appropriate corrections. Such methods are also capable of measuring any selected angular relationships between holders.

Once the holders 20, 22 are arranged in the parallel relationship, substrates 24, 26 are placed onto the holders 20, 22, which hold the outer surfaces of the substrates 24, 26 by one of several methods discussed below. (In other embodiments of the invention, it is possible for the inner surfaces of the holders to be brought into a parallel relationship at later stages in the process, e.g., after the substrates 24, 26 are placed onto the holders 20, 22.) FIG. 6a shows the holders 20, 22 and substrates 24, 26 before the substrates 24, 26 are held to the surfaces of the holders 20, 22. Substrate 24 is shown with gradual, wavy thickness variations, and substrate 26 is shown with a wedge type variation.

As shown in FIG. 6b, a force or attraction causes the outer surfaces of the substrates 24, 26 to substantially comply to the continuous surface portions (not shown) of the holders 20, 22. It is possible for the outer surfaces of the substrates 24, 26 to be held by vacuum, by electrostatic or magnetic attraction, or by a temporary chemical bond such as an adhesive. In certain cases where a temporary bond or electrostatic attraction are used, such as where thin, flexible substrates are used, the substrates 24, 26 will have to be pressed upon the holders 20, 22 in a manner that provides compliance to the surfaces of the holders 20, 22. One such manner is the use of a roller. Once the outer surfaces of the substrates 24, 26 are held onto the inner surfaces of holders 20, 22, the Fizeau or similar method is able to confirm the parallelism of the inner surfaces of the holders 20, 22, if the substrates 24, 26 are of a transparent material that allows use of the method. For example, if the substrates 24, 26 are transparent and have an anti-reflective coating on the side contacting the holder, it is possible for a Fizeau method to be used successfully. As discussed above, the inner surfaces of holders 20, 22 contain a continuous surface portion.

In accordance with this embodiment of the invention, with the substrates 24, 26 held in compliance with the flat surfaces of the holders 20, 22, an adherent 28 is applied to an inner surface of substrate 26. It is also possible to apply the adherent at an earlier stage in the process. A previously formed optical article 29 is inserted on adherent 28. For example, the optical article may be a polarizer, half or quarter wave plate, neutral density filter, birefringent plate, or diffractive optic. An adherent 27 is applied to the outer surface of previously formed optical article 29. Holder 20 brings the inner surface of substrate 24 into contact with the adherent 27 while the inner surfaces of the holders 20, 22 (and thus the outer surfaces of the first and second substrates 24, 26) are kept in the parallel relationship, as shown in FIG. 6c. The holders 20, 22 should press the substrates 24, 26 together with enough force to obtain a desired spread of adherents 27, 28 around the optical article 29 between the substrates 24, 26 and/or obtain a desired level of contact between the adherents 27, 28 and substrates 24, 26. It is useful to perform the Fizeau or similar method to confirm parallelism while the holders 20, 22 are grasping the substrates 24, 26 and pressing the substrates 24, 26 together with the adherents 27, 28, and before curing the adherents 27, 28.

The adherents 27, 28 are then at least partially cured such that when the holders 20, 22 are removed, the rigidity or force exerted on the inner surfaces of the substrates 24, 26 by the adherents 27, 28 with the encased optical article 29 maintains the substantially parallel relationship (i.e., the low bow) and the surface and transmission flatness imparted to the outer surfaces of the substrates 24, 26. The bow and flatness are maintained within the area of the continuous surface portions of the holders 24, 26, and primarily in the area contacted by the adherents 27, 28, as discussed above. The forces involved in maintaining this relationship are discussed below.

For ease of discussion, the holders 20, 22 are described in this embodiment as separate holders. It is possible, however, for the holders to be two pieces of a single part.

In an embodiment of the invention using one substrate, as reflected in FIG. 5, it is possible to produce an encased optical article utilizing one substrate and a layer of adherent to encase a previously formed optical article. In this embodiment of the invention, with the substrate 32 held in compliance with the flat surface of holder 30, an adherent 34 is applied to the inner surface of substrate 32. A previously formed optical article 39 is inserted on adherent 34. An adherent 38 sufficient to encase the optical article 39 is then applied to the surface of optical article 39. Holder 36 is brought into contact with the adherent 38 while the inner surfaces of the holders 30, 36 are kept in a parallel relationship. In this manner, the outer surface of substrate 32 and adherent 38 are kept in a parallel relationship. The holders 30, 36 should press substrate 32 and adherent 38 together with enough force to obtain a desired level of contact between adherent 38 and the inner surface of holder 36.

Adherents 32, 38 are then at least partially cured such that when holders 30, 36 are removed, the rigidity or force exerted on the inner surface of substrate 32 by the adherent 34 maintains the substantially parallel relationship and the surface and transmission flatness imparted to the outer surfaces of substrate 32 and outer surface of adherent 38. The bow and flatness are maintained within the area of the continuous surface portions of holders 30, 36, and primarily in the area contacted by adherents 34, 38.

In a further embodiment of the invention, it is possible to produce an encased optical article utilizing two layers of adherent to encase a previously formed optical article. No substrates are used. In this embodiment of the invention, an adherent is applied to the inner surface of a first holder. A previously formed optical article is inserted on the adherent. An adherent sufficient to encase the optical article is then applied to the surface of optical article. A second holder is brought into contact with the adherent while the inner surfaces of both the first and second holder are kept in a parallel relationship. In this manner, the outer surfaces of the adherents encasing the optical article are kept in a parallel relationship. The holders should press the adherents encasing the optical article together with enough force to obtain a desired level of contact between the adherents and the holders. The adherents are then at least partially cured such that when the holders are removed, the substantially parallel relationship and the surface and transmission flatness imparted to the outer surfaces of the adherents by the holders are maintained. The bow and flatness are maintained within the area of the continuous surface portions of the holders.

The method of the present invention is advantageously performed in a clean room environment. Among other things, a clean room helps prevent contaminants such as dust particles from lodging between the holders, substrates, and/or adherent. With thickness variations measured in wavelengths, it is apparent that even a single dust particle (typically having a diameter of 1 to 10 wavelengths) affects the flatness of the overall article.

The adherent is disposed onto the substrate or substrates by any suitable method, and is used in liquid or solid form. The adherent may be introduced by applying the adherent at the edges of the multilayer structure and allowing the capillary forces between the substrates/optical article to draw in the adherent. In addition, the adherent may be applied to the substrates/optical article via a syringe or pipette, or injected onto the substrates/optical article from any mixing or metering equipment. Furthermore, the adherent can be coated to either or both substrates via various techniques known to those skilled in the art. These techniques can be manual using bird blades, or wire-wound rods to coat a desired thickness of adherent to the substrates. Alternatively, coating equipment can also be used. Various equipment and machinery available in different designs and configurations can apply the desired amount of the adherent to the substrates. Examples of coating equipment include, but are not limited to, roll coaters where a substrate is passed between rolls to deposit adherent onto the substrates. Roll coatings include reverse-roll coaters, kiss coaters, nip coaters, gravure coaters, bead coaters, and dip coaters. Other coating machines include knife coaters, round bars, wire-wound bars, bull noses, air doctors, brushes, spray coaters, extrusion coaters, cast coaters, and calender coaters. The substrates may have a hole through which adherent is injected. The adherent comprises any material that sufficiently adheres and/or provides rigidity to the substrate or substrates and encased optical article such that the upon removal of the holders the substrate or multilayer article with encased optical article is maintained in a posture at which it was held by the holder or holders.

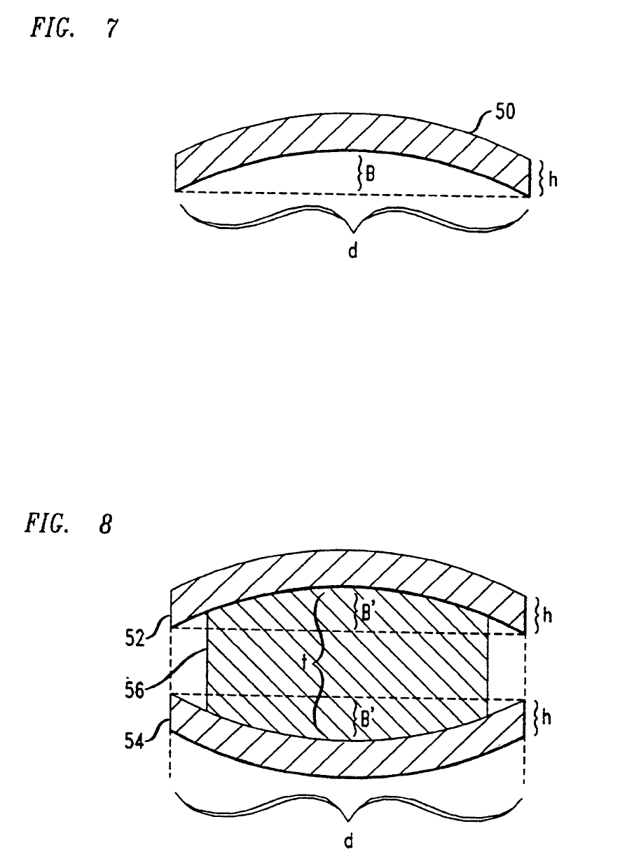

While not limiting the invention to any particular model or theory, it is believed that the force required for maintenance of the posture can be represented by the following simplistic model, for both a single substrate and for two substrates. See also L. D. Landau et al., Theory of Elasticity, Pergamon Press, Oxford, 3d English Ed., 1986, particularly page 44. For the equations below, the substrates are circular and initially have spherical bow, and the goal is to achieve a bow of zero. For a single substrate 50, as reflected in FIG. 7, the pressure difference across the substrate, P, necessary to produce compliance (i.e., reducing the bow to zero) is given by:

$$P = ( \frac{256}{3} ) ( \frac{{bh}^{3}}{{d}^{4}} ) ( \frac{E}{( 1 - σ ) ( 5 + σ )} )$$

where:

h=substrate thickness

b=height of substrate bow in center

d=diameter of substrate

P1=air pressure on free surface of substrate

P2=air pressure on vacuum flat surface of substrate

P=P1−P2=pressure difference across substrate

σ′=Poisson's ratio of substrate

E=Young's modulus of substrate

In the three-layer article of FIG. 8, there will exist a residual bow height, b′, as the substrates 52, 54 (each having an initial bow height, b, as above) attempt to return to their original form and thereby push against the adherent layer 56. Additional parameters for this model are:

b′=residual bow height in three-layer article

t=bonding layer thickness (t>>b′)

σ′=Poisson's ratio of adherent layer

E′=Young's modulus of adherent layer

For this simplified model, the ratio of the final cell surface bow height to the cell diameter is given by:

$$( \frac{{b}^{′}}{d} ) = ( \frac{128}{3} ) ( \frac{E}{E} ) ( \frac{{bh}^{3} t}{{d}^{5}} ) ( \frac{( 1 + {σ}^{′} ) ( 1 - 2 {σ}^{′} )}{( 1 - {σ}^{′} ) ( 1 - {σ}^{′} ) ( 5 + {σ}^{′} )} )$$

The adhesive strength between the adherent layer and the substrates thus needs to exceed the pressure differential P that is required to displace either substrate by an amount equal to (b−b′). For example, for b′<0.1 micrometers (approximately 0.2 wavelengths), d equal to 50 mm, t equal to 1 mm, E/E′ equal to 2, σ′ equal to approximately 0.25, σ′ equal to approximately zero, and h equal to 1 mm, the limit for initial substrate bow (2b/d) is less than ¼.

It is possible for the adherent to be photocurable or otherwise curable, e.g., radiation or chemical curable. Heat may be used to accelerate a radiation cure. It is also possible for the adherent to be a material that undergoes a phase transformation, e.g., liquid to solid, to attain a required adherence. As used herein, the terms cure and curable are intended to encompass materials that gel or solidify by any such methods. Photocurable adherents include materials that cure upon exposure to any of a variety of wavelengths, including visible light, UV light, and x-rays. It is also possible to use adherents that are curable by electron or particle beams. Useful adherents include photocurable adherents that are photosensitive, the term photosensitive meaning a material that changes its physical and/or chemical characteristics in response to exposure to a light source (e.g., selective, localized exposure). Such photosensitive adherents include but are not limited to certain photosensitized acrylates and vinyl monomers. Photosensitive adherents are useful because they act as both an adherent and a recording media. Adherents such as those based on epoxides are also useful.

It is possible for the adherent to comprise additives such as adherence-promoters, photoinitiators, absorptive materials, or polarizers. The thickness of the post-cure adherent will vary depending on several factors, including the adherent used, the method of application, the amount of adherent applied, and force exerted on the adherent by the substrates. Different thickness will be desired for different applications. The level of cure needed is determined by the particular adherent used and by the force required to maintain a substrate or multilayer article with the encased optical article in the position imparted by the holder or holders. For materials that are photocurable, heat curable, or chemically curable, it is possible for suitable cures to range from a few percent to 100%. For materials that undergo a complete phase transformation, e.g., liquid to solid, to attain the needed adherence, a complete phase transformation is considered to be a complete cure for the purposes of this application.

It is advantageous for the adherent to have, after the at least partial cure, a refractive index close to that of the substrate and the encased optical article. Having a multilayer article with a near-uniform refractive index is advantageous because, as shown in the discussion of OPL above, a near-uniform refractive index through certain areas in an article will reduce the change in OPL in those areas. In other words, thickness variations in a substrate will not have a large effect on the delta OPL if the adherent that fills or compensates for such variations has a refractive index close to the index of the substrate itself. For example, where two substrates each have a thickness variation of 5 waves/cm (i.e., total of 10 waves/cm), the refractive index is desirably within 1% (0.01) of the average of the refractive indices of the substrates in order to maintain a transmission flatness of 0.1 waves/cm. Where two substrates are used, the substrates advantageously have refractive indices that are equivalent to two decimal places, and the refractive index of the adherent is advantageously equivalent to two decimal places to the average of the refractive indices of the first and second substrates. In some applications, it is advantageous for the adherent to be of high optical quality, e.g., homogeneous, bubble-free, and low scattering.

The holders have a continuous surface portion on their inner surfaces to which the substrate or substrates substantially comply, as discussed above. The holders are advantageously vacuum chucks, meaning a flat surface in which the inner surfaces of the holders have one or more grooves, where a grasping force is created by application of a vacuum to the substrate through the groove or grooves. Alternatively, the grasping steps are performed by use of electrostatic or magnetic attraction, or by temporary chemical bonding (e.g., adhesive). The grasping or temporary bonding force holds the substrate against the inner surface of the holder, attaining substantial compliance, particularly over the continuous surface portion of the inner surface, as discussed above. The required force will vary depending on the parameters of the particular substrates used, e.g., composition, thickness, initial flatness, flexibility. In an embodiment using two holders, the holders are arranged in any way that allows the attainment of the selected angular relationship, such as the arrangement given in the embodiment above.

It is advantageous in a two-holder configuration for at least one holder to be attached to a mechanism that allows the holder to move along its z-axis with very little resistance during the curing step. (The x- and y-axes define the plane on which the adherent is disposed, and the z-axis is the remaining axis.) For example, the holder could be attached to a piston mechanism that equalizes the downward pressure caused by the weight of the holder and substrate, thereby allowing the holder to almost float along the z-axis while remaining fixed in pitch and yaw. Providing such a mechanism is advantageous because some adherents will contract during curing, and, if both holders were immovably fixed during the cure, it is possible for such contraction to detrimentally affect both the adhesion between the adherent and the substrates and the angular relationship between the holders.

It is possible for the holders to be made from any material that maintains a flat surface and is able to apply a grasping force to the substrates or adequately maintain a temporary chemical bond. In the case of a photocurable adherent, as discussed above, the holders are advantageously glass or another material that allows enough light transmission to obtain an adequate cure, and allows use of a Fizeau or similar method to confirm parallelism of the holders are advantageous. In the case of adherents that do not require light to cure, it is possible to use non-transparent materials, but other methods for confirming the angular relationship of such materials must be used. The material selected for the holder also depends on the type of grasping force or temporary bond utilized, e.g., adhesive bond or magnetic attraction, and on the intended use of the multilayer article or substrate being fabricated.

The first and second substrates are of the same or different materials and are formed from ceramics (including glasses), silicon, metals, polycarbonate, polymethylmethacrylate, or acrylic, or plastics depending on the intended use of the article or substrate being formed. Also, as discussed above in relation to the holders, it is possible for the substrates to be multiple pieces of a single part. The substrates are of any required shape. For example, the substrates may be square, rectangular, circular, or oval. The substrates advantageously do not have flatness variations at such a high level that application of the grasping force could not attain substantial compliance with a holder surface without damaging the substrates. In addition to self-supporting substrates such as glass plates, it is possible for the substrates to be a polymeric material that is sprayed onto a holder, a thin polymer film such as Mylar Registered TM, or a polymer sheet such as polycarbonate. It is also possible for a polymeric material or film to be combined with a self-supporting material such as a glass plate to form a single substrate. The materials or films of such two-layer substrates may be photosensitive material, and the method of the invention is useful in improving the optical properties of such substrates. The substrates themselves may be an optical article such as, for example, a polarizer, half or quarter wave plate, neutral density filter, birefringent plate, or diffractive optic. For example, a cross-polarizer may be constructed utilizing a polarizer substrate and a polarizer inserted optical article. The substrates may have surface relief patterns such as those used as tracking patterns embossed onto the surface of disks used as recording media in the optical data storage industry with features typically smaller than or equal to the wavelength of visible light.

It is important to design the Fizeau method to confirm parallelism and quality of the outer surfaces of the substrates. For example, it is advantageous to use plane wave illumination and wedged holders that are optically flat on both sides. In addition, antireflective (AR) coatings on substrates are advantageous for several reasons. Without an AR coating, no interface reflection exists between the substrate surface and the surface of the holder, making it difficult to utilize an interferometric method for determining the selected angular relationship. In addition, van der Waals and residual vacuum forces between the substrate and holder make separation of the substrate from the holder difficult, and antireflective coatings reduce such forces. Also, antireflective coatings enhance light throughput and reduce internal reflections within a multilayer substrate. Advantageously, only the side of the substrate that contacts the holder is given an AR coating. It is possible for AR coating on the side of a substrate on which the adherent is disposed to induce poor adhesion and/or cause unwanted additional reflections between the adherent and the substrate. In some configurations, however, other coatings, such as adhesion-promoters, are advantageously disposed on the side of the substrate on which the adherent is disposed. Such coatings are advantageously no thicker than 500 Angstroms.

In an embodiment of the invention using two substrates, it is possible to compensate for wedge type thickness variations, because the inner surfaces of the holders impart a selected angular relationship to the outer surfaces of the substrates, and wedge type variations in the substrates are translated to the interior of the article, where the adherent compensates for the variation while the angular relationship is maintained. The adherent similarly compensates for sharp or gradual wavy variations on the inner surfaces of the substrates by f_{g} in such variations. It is possible to compensate for gradual, wavy variations on the side of the substrate on which no adherent has been disposed if (a) the method is performed such that at least some of the gradual wavy variations on the side of the substrate that complies with the holder are transmitted to the opposing side of the substrate, and (b) the adherent fills in or overlays the transmitted variations on that opposing side of the substrate. In addition, if the adherent in such a multilayer article has a post-cure refractive index close to the refractive index of the substrate, a near-uniform refractive index will be achieved in areas containing the adherent, and the change in optical path length across these areas of the article will therefore be reduced.

The method of the invention is useful for forming a variety of articles, particularly for use in optical systems, including high quality mirrors, flats, windows, prisms, beam splitters, filters, and lenses. In addition, the adherent may be capable of supporting photodefined patterns such as holographic patterns. In this case the adherent may belong to a class of photopolymers used as holographic recording media. Memory cells for holographic data storage systems are discussed, for example, in H. -Y. Li et al., “Three-dimensional holographic disks,” Appl. Opt., 33, pp. 3764-3774 (1994), and A. Pu et al., “A new method for holographic data storage in photopolymer films,” Proceedings from IEEE/IEOS 1994 Symposium, pp. 433-435, the disclosures of which are hereby incorporated by reference. It is also possible for cells made according to the invention to be used for digital holographic storage, in which the cells currently must have a surface and transmission flatness of about 0.25 waves/cm or better and a bow of about 10⁻² or less. Conventional methods of disposing photopolymers between substrates do not provide these needed properties.

In forming a holographic memory cell, two substrates are advantageously used, and both substrates are advantageously the same material. An optical article may be inserted between the two substrates, with a layer of adherent between the inserted optical article and each substrate. This embodiment provides for two layers of adherent capable of holographic data storage when the adherent used is a photopolymer material. The substrates are advantageously selected from glass, sapphire, polycarbonate, and quartz. Any other material that is transparent to the wavelength being used in the holographic storage system, and which has adequate mechanical properties for a memory cell, may also be used as a substrate. The substrates are advantageously about 0. 1 to about 1 mm thick. An initial substrate will typically have surface flatness and transmission flatness values of about 0.1 to about 10 waves/cm, and a bow of about 0.1 or less. Commercially available display glass exhibits these properties, and is typically free from significant divots and peaks, meaning scratch and dig of 40/20 or better. Such display glass is suitable for fabrication of a memory cell.

As discussed above, having an adherent with a refractive index close to that of the substrates is advantageous because a near-uniform refractive index throughout a multilayer article will reduce variations in OPL. In fabricating a holographic memory cell for digital holography, it is advantageous for the refractive index of the first substrate to be equivalent to two decimal places to the refractive index of the second substrate, and for the refractive index of the adherent to be equivalent to two decimal places to the average of the refractive indices of the first and second substrates.

It is also advantageous for the adherent in a holographic cell to be applied in a continuous layer, and for the adherent to be a photopolymer, i.e., capable of storing data in a holographic data storage system after a cure. Photopolymers such as those discussed above have been found to be useful adherents for holographic memory cells made according to the invention because these materials function both as adherents and as photosensitive recording media. After the cure, the thickness of the adherent in a memory cell is advantageously about 0.2 to about 2 mm. The post-cure memory cell advantageously has surface flatness and transmission flatness values of about 0.05 to about 0.25 waves/cm, more advantageously, about 0.05 to about 0.1 waves/cm, and a bow of about 10⁻² or less. The memory cell also advantageously has a Strehl value of about 0.9 or greater. As discussed above, these properties refer to the area of the multilayer article within the area of the continuous surface portions of the inner surfaces of the holders, and primarily where the adherent contacts the substrates. The areas of the substrates extending past the adherent-contact area typically will not exhibit these properties. The uniform, circular area is where the continuous layer of adherent contacts the inner surfaces of the substrates, and is within the area defined by vacuum grooves in the holders. The outer area with a higher density of fringes has no photopolymer between the glass substrates, and the fringe density arises from the uncorrected transmission flatness of the two substrates.

A useful quality factor, or Q, for evaluating the properties of a memory cell made according to the method of the present invention is the Strehl value divided by the waves/cm rms transmission flatness, as measured over a predetermined area. Advantageously, memory cells made according to the method of the present invention have a Q greater than 1, and more advantageously, greater than 4. As a comparison, display glass typically has a Q of about 0.5, window glass a Q of about 0.05. In the absence of the invention's steps of grasping substrates such that they substantially comply with at least the continuous surface portions of the inner surfaces of the holders, cells consisting of two substrates with adherent disposed in between would have a Q of about 0.08, primarily due to the initial Strehl of the glass, holder distortions, and shrinkage of the adherent.

The present invention further relates to a system, e.g., an optical system, containing a multilayer article that comprises one or two substrates and a layer of at least partially cured adherent adhered to the substrate or substrates, wherein the article has surface flatness and transmission flatness values of about 0.05 to about 0.25 waves/cm, preferably, 0.05 to about 0.1 waves/cm, and wherein the force exerted by the adherent on the substrate or substrates maintain this flatness. In some applications, the article also has a bow of about 10⁻² or less (advantageously about 10⁻⁵ or less for reflective applications), and, in such applications, the force exerted by the adherent on the substrates maintains the bow as well. It is possible for the system to be a holographic storage system, in particular, a digital holographic data storage system. The elements of holographic storage systems are discussed, for example, in the articles cited above, as well as S. Pappu, “Holographic memories; a critical review,” Int. J. Optoelect., 5, pp. 251-292 (1990); L. Hesselink et al., “Optical memories implemented with photorefractive media,” Opt. Quant. Elect., 25, §§ 611-661 (1993); and D. Psaltis et al., “Holographic Memories,” Scientific American, November 1995, the disclosures of which are hereby incorporated by reference. The parameters of the memory cell of the holographic data storage system are as discussed above.

The invention will be further clarified by the following example, which is intended to be purely exemplary.

### EXAMPLE 1

The method of the present invention was utilized to encase a polarizing material in an optically flat package to create an optically flat polarizer. Prior to creating the optically flat polarizer, the polarizing material exhibited variations in its optical flatness of more than 1.73 waves/cm.

Two 10 cm diameter, about 1.9 cm thick glass flats having a surface flatness of 0.005 waves/cm were utilized for holders. In each holder a circular vacuum-accessible groove about 3.2 mm wide by about 1.6 mm deep was carved, the groove having an inner diameter of about 6.4 cm. The holders were cleaned by a drop and drag method using acetone and then methanol.

Square glass substrates of display glass, having an antireflective coating on one side, measuring 75 mm by 75 mm by about 1.11 mm, and having surface flatness and transmission flatness values of about 1 wave/cm, were similarly cleaned. Alternatively, the substrates may be cleaned by applying a solvent to the surface of the substrate followed by spinning the substrate to evaporate the solvent. The holders were mounted into an apparatus such that they were located one over the other, and their vacuum grooves were attached to a house vacuum at approximately 0.1 atmosphere. The holders were arranged such that the bottom holder could be rotated in pitch and yaw, but did not move along the z-axis, whereas the top holder was fixed in pitch and yaw but moved vertically along the z-axis. To measure the parallelism of the holders, an expanded, collimated HeNe laser beam was directed at the central portion of the holders from above, at a slight angle. The reflection from the two inner surfaces of the holders when the holders were brought nearly into contact indicated the degree of parallelism of the holders. The bottom holder was adjusted until the interference reflection showed a bulls-eye pattern, which indicated a parallel relationship to within 0.05 waves/cm.

Once the parallelism was established, the top holder was moved up, the vacuum pump was started, and the substrates were placed onto the inner surfaces of the holders such that the side of the substrates having the antireflective coating contacted the holders. The force of the vacuum (approximately 0.1 atmosphere) caused substantial compliance of the substrates with the surface of the holders, primarily over the area surrounded by and including the vacuum grooves. About 0.4 mL of an ultraviolet curable adherent was introduced on the inner surface of the bottom substrate with a syringe and hypodermic needle until the UV adherent formed a small pool of liquid. (The amount of adherent liquid required to form a 65 mm diameter pool is approximately 1 mL per 250 micrometers of layer thickness.) The polarizing material was placed onto the inner surface of the bottom substrate over the pool of UV adherent. About another 0.4 mL of the ultraviolet adherent was introduced on the inner surface of the polarizing material with a syringe and hypodermic needle until the UV adherent formed a small pool of liquid. The upper substrate was brought down into contact with the adherent, and the force between the substrates caused the adherent to spread across the inner surfaces of the sandwiched polarizing material between the substrates in a circular pattern.

The parallelism was confirmed with the Fizeau method by adjusting the laser light to correspond with the axis of the polarizing material. The cell was illuminated from above with a uniform intensity ultraviolet flood lamp for approximately 20-30 minutes to insure the curing of the ultraviolet adherent through the polarizing material. The vacuum was then released and the multilayer cell removed.

The area of the finished cell where the adherent contacted the substrates, which was within the continuous surface portion defined by the vacuum grooves of the holders, had an rms surface and transmission flatness values of better than

1. A method for forming a multilayer optical article comprising:
grasping an outer surface of a first substrate with a first holder, whereby the outer surface of the first substrate is held to an inner surface of the first holder;
grasping an outer surface of a second substrate with a second holder, whereby the outer surface of the second substrate is held to an inner surface of the second holder;
arranging the inner surfaces of the first and second holders to face one another in a selected angular relationship;
inserting an optical article between the first and second substrate, wherein a first layer of adherent is between a first surface of the optical article and the inner surface of the first substrate, and a second layer of adherent is between a second surface of the optical article and the inner surface of the second substrate;
moving the first and second holders toward each other such that the inner surfaces of the first and second substrates contact the first and second layer of adherent with the optical article in between the first and second layer of adherent; and
at least partially curing the adherent while the inner surfaces of the first 20 and second holder s are in the selected angular relationship to form a multilayer article encasing the optical article, wherein after removal of the first and second holder, the at least partially cured adherent maintains the multilayer article containing the optical article in the posture at which the multilayer article was held by the first and second holders.

2. The method of claim 1, wherein said step of inserting an optical article between the first and second substrate comprises:
disposing an adherent on the inner surface of the first substrate or the inner surface of the second substrate;
inserting a previously formed optical article on the adherent; and
disposing an adherent on the surface of the previously formed optical article.

3. The method of claim 2, wherein said step of disposing an adherent comprises drawing in via capillary action an adherent.

4. The method of claim 2, wherein said step of disposing an adherent comprises injecting, extruding, pouring, pipetting, roll coating, blade coating, or spraying an adherent.

5. The method of claim 2, wherein the step of disposing an adherent on the inner surface of the first substrate or the inner surface of the second substrate comprises dispensing the adherent through a hole in the first or second substrate via a corresponding hole in the first or second holder.

6. The method of claim 1, wherein the outer surface of a substrate is held to an inner surface of a holder using a vacuum force.

7. The method of claim 1, wherein the outer surface of a substrate is held to an inner surface of a holder using an electromagnetic force.

8. The method of claim 1, wherein the holders are transparent plates.

9. The method of claim 1, wherein the holders have at least one vacuum groove therein for applying a vacuum force to a substrate.

10. The method of claim 1, wherein the holders have at least one hole for dispensing an adherent through the holder.

11. The method of claim 1, wherein the substrates are made from glass, silicon, polycarbonate, polymethylmethacrylate, acrylic, or any combination thereof.

12. The method of claim 1, wherein the substrates have at least one hole for dispensing an adherent through the substrate.

13. The method of claim 1, wherein the geometric form of the substrates may be square, rectangular, circular, or oval.

14. The method of claim 1, wherein the substrates are about 25 micrometers to about 3 millimeters in thickness.

15. The method of claim 1, wherein the outer surface of the first or second substrates contain surface relief patterns.

16. The method of claim 1, wherein the inner surface of the first or second substrate contain a surface relief pattern or a diffractive grating.

17. The method of claim 1, wherein the first or second substrate is an optical article.

18. The method of claim 17, wherein the optical article is a polarizers half wave plate, quarter wave plate, or neutral density filter.

19. The method of claim 1, further comprising the step of cleaning the inner or outer surface of the first or second substrate before grasping by the first or second holder.

20. The method of claim 19, wherein the step of cleaning comprises:
applying a cleaning solvent to the surface of the substrate; and
evaporating the solvent by spinning the substrate.

21. The method of claim 1, wherein the multilayer article encasing the optical article has an average surface flatness of about 0.05 waves/cm to about 1 wave/cm at wavelengths of about 300 nanometers to 1600 nanometers.

22. The method of claim 1, wherein the multilayer article encasing the optical article has an average transmission flatness of about 0.05 waves/cm to about 1 wave/cm at wavelengths of about 300 nanometers to 1600 nanometers.

23. The method of claim 1, wherein the adherent is cured utilizing thermal or radiation energy.

24. The method of claim 23, further comprising the use of heat to accelerate curing of the radiation energy.

25. The method of claim 1, wherein the inserted optical article is a polarizer, birefringent plate, diffractive optic, neutral density filter, half wave plate, or quarter wave plate.

26. The method of claim 9, wherein the multilayer article is released from the holders by injecting a gas into the holder vacuum grooves.

27. The method of claim 1, wherein the selected angular relationship is a parallel relationship.

28. The method of claim 1, wherein the multilayer article has a Strehl value of 0.9 or greater.

29. The method of claim 1, wherein during the curing step either the first or second holder is allowed to move along a z-axis.

30. A method for forming a multilayer optical article comprising:
grasping an outer surface of a substrate with a first holder, whereby the outer surface of the substrate is held to an inner surface of the first holder;
arranging the inner surfaces of a second holder and the first holder to face one another in a selected angular relationship;
inserting an optical article between the substrate and the second holder, wherein a first layer of adherent is between a first surface of the optical article and the inner surface of the substrate, and a second layer of adherent is between a second surface of the optical article and the inner surface of the second holder;
moving the first and second holders toward each other such that the inner surfaces of the substrate and second holder contact the first and second layer of adherent with the optical article in between the first and second layer of adherent; and
at least partially curing the adherent while the inner surfaces of the first and second holders are in the selected angular relationship to form a multilayer article encasing the optical article, wherein after removal of the first and second holder, the at least partially cured adherent maintains the multilayer article containing the optical article in the posture at which the multilayer article was held by the first and second holders.

31. The method of claim 30, wherein said step of inserting an optical article between the substrate and second holder comprises:
disposing an adherent on the inner surface of the substrate;
inserting an optical article on the adherent; and
disposing an adherent on the surface of the previously formed optical article.

32. The method of claim 31, wherein said step of disposing an adherent comprises drawing in via capillary action an adherent.

33. The method of claim 31, wherein said step of disposing an adherent comprises injecting, extruding, pouring, pipetting, roll coating, blade coating, or spraying an adherent.

34. The method of claim 31, wherein the step of disposing an adherent on the inner surface of the substrate comprises dispensing the adherent through a hole in the substrate via a corresponding hole in the first or second holder.

35. The method of claim 30, wherein the outer surface of the substrate is held to an inner surface of a holder using a vacuum force.

36. The method of claim 30, wherein the outer surface of the substrate is held to an inner surface of a holder using an electromagnetic force.

37. The method of claim 30, wherein the holders are transparent plates.

38. The method of claim 30, wherein the holders have at least one vacuum groove therein for applying a vacuum force to the substrate.

39. The method of claim 30, wherein the holders have at least one hole for dispensing an adherent through the holder.

40. The method of claim 30, wherein the substrate is made from glass, silicon, polycarbonate, polymethylmethacrylate, acrylic, or any combination thereof.

41. The method of claim 30, wherein the substrate has at least one hole for dispensing an adherent through the substrate.

42. The method of claim 30, wherein the geometric form of the substrate may be square, rectangular, circular, or oval.

43. The method of claim 30, wherein the substrate is about 25 micrometers to about 3 millimeters in thickness.

44. The method of claim 30, wherein the outer surface of the substrate contains surface relief patterns.

45. The method of claim 30, wherein the inner surface of the substrate contains a surface relief pattern or a diffractive grating.

46. The method of claim 30, wherein the substrate is an optical article.

47. The method of claim 46, wherein the optical article is a is a polarizer, neutral density filter, half wave plate, or quarter wave plate.

48. The method of claim 30, further comprising the step of cleaning the inner or outer surface of the substrate before grasping by the first holder.

49. The method of claim 48, wherein the step of cleaning comprises:
applying a cleaning solvent to the surface of the substrate; and
evaporating the solvent by spinning the substrate.

50. The method of claim 30, wherein the multilayer article encasing the optical article has an average surface flatness of about 0.05 waves/cm to about 1 wave/cm at wavelengths of about 300 nanometers to 1600 nanometers.

51. The method of claim 30, wherein the multilayer article encasing the optical article has an average transmission flatness of about 0.05 waves/cm to about 1 wave/cm at wavelengths of about 300 nanometers to 1600 nanometers.

52. The method of claim 30, wherein the adherent is cured utilizing thermal or radiation energy.

53. The method of claim 52, further comprising the use of heat to accelerate curing of the radiation energy.

54. The method of claim 30, wherein the inserted optical article is a polarizer, birefringent plate, or diffractive optic.

55. The method of claim 35, wherein the multilayer article is released from the holders by injecting a gas into the holder vacuum grooves.

56. The method of claim 30, wherein the selected angular relationship is a parallel relationship.

57. The method of claim 30, wherein the multilayer article has a Strehl value of 0.9 or greater.

58. The method of claim 30, wherein during the curing step either the first or second holder is allowed to move along a z-axis.

59. A method for forming a multilayer optical article comprising:
disposing a first adherent on an inner surface of a first holder;
inserting an optical article on the first adherent;
disposing a second adherent on the surface of the previously formed optical article;
moving the first and second holders toward each other such that the second holder contacts the second adherent with the optical article in between the first and second layer of adherent; and
at least partially curing the adherent while the inner surfaces of the first and second holders are in a selected angular relationship to form a multilayer article encasing the optical article, wherein after removal of the first and second holder, the at least partially cured adherent maintains the multilayer article containing the optical article in the posture at which the multilayer article was held by the first and second holders.

60. The method of claim 59, wherein said step of disposing an adherent comprises drawing in via capillary action an adherent.

61. The method of claim 59, wherein said step of disposing an adherent comprises injecting, extruding, pouring, pipetting, roll coating, blade coating, or spraying an adherent.

62. The method of claim 59, wherein the multilayer article encasing the optical article has an average surface flatness of about 0.05 waves/cm to about 1 wave/cm at wavelengths of about 300 nanometers to 1600 nanometers.

63. The method of claim 59, wherein the multilayer article encasing the optical article has an average transmission flatness of about 0.05 waves/cm to about 1 wave/cm at wavelengths of about 300 nanometers to 1600 nanometers.

64. The method of claim 59, wherein the adherent is cured utilizing thermal or radiation energy.

65. The method of claim 64, further comprising the use of heat to accelerate curing of the radiation energy.

66. The method of claim 59, wherein the inserted optical article is a polarizer, birefringent plate, or diffractive optic.

67. The method of claim 59, wherein the selected angular relationship is a parallel relationship.

68. The method of claim 59, wherein the multilayer article has a Strehl value of 0.9 or greater.

69. The method of claim 59, wherein during the curing step either the first or second holder is allowed to move along a z-axis.

70. A multilayer article comprising:
a first substrate;
a second substrate;
an article located between the first substrate and the second substrate;
a first layer of partially cured adherent, wherein the first layer of partially cured adherent is disposed between the first substrate and the article; and
a second layer of partially cured adherent, wherein the second layer of partially cured adherent is disposed between the second substrate and the article.

71. The multilayer article of claim 70, wherein the multilayer article has a surface flatness of about 0.05 waves/cm to about 1 wave/cm at wavelengths of about 300 nanometers to 1600 nanometers and a transmission flatness of about 0.05 waves/cm to about 1 wave/cm at wavelengths of about 300 nanometers to 1600 nanometers, wherein the force exerted by the adherents on the first and second substrates maintains the surface and transmission flatness.

72. The multilayer article of claim 70, wherein the substrates are made from glass, silicon, polycarbonate, polymethylmethacrylate, acrylic, or any combination thereof.

73. The multilayer article of claim 70, wherein the substrates have at least one hole for dispensing an adherent through the substrate.

74. The multilayer article of claim 70, wherein the geometric form of the substrates may be square, rectangular, circular, or oval.

75. The multilayer article of claim 70, wherein the substrates are about 25 micrometers to about 3 millimeters in thickness.

76. The multilayer article of claim 70, wherein the outer surface of the first or second substrates contain surface relief patterns.

77. The multilayer article of claim 70, wherein the inner surface of the first or second substrate contain a surface relief pattern or a diffractive grating.

78. The multilayer article of claim 70, wherein the first or second substrate is an optical article.

79. The multilayer article of claim 70, wherein the article is a polarizer, half wave plate, quarter wave plate, or neutral density filter, birefringent plate, or diffractive optic.

80. The multilayer article of claim 70, wherein the adherent is cured utilizing thermal or radiation energy.

81. The multilayer article of claim 70, wherein the article has a Strehl value of 0.9 or greater.

82. A multilayer article comprising:
a substrate;
an article;
a first layer of at least partially cured adherent, wherein the first layer of adherent is disposed between the substrate and a first surface of the article;
a second layer of at least partially cured adherent, wherein the second layer of adherent is disposed on a second surface of the article.

83. The method of claim 82, wherein the multilayer article has a surface flatness of about 0.05 waves/cm to about 1 wave/cm at wavelengths of about 300 nanometers to 1600 nanometers and a transmission flatness of about 0.05 waves/cm to about 1 wave/cm at wavelengths of about 300 nanometers to 1600 nanometers, wherein the force exerted by the adherent on the first substrate maintains the surface and transmission flatness.

84. The multilayer article of claim 82, wherein the substrate is made from glass, silicon, polycarbonate, polymethylmethacrylate, acrylic, or any combination thereof.

85. The multilayer article of claim 82, wherein the substrate has at least one hole for dispensing an adherent through the substrate.

86. The multilayer article of claim 82, wherein the geometric form of the substrate may be square, rectangular, circular, or oval.

87. The multilayer article of claim 82, wherein the substrate is about 25 micrometers to about 3 millimeters in thickness.

88. The multilayer article of claim 82, wherein the outer surface of the substrate contains a surface relief pattern.

89. The multilayer article of claim 82, wherein the inner surface of the substrate contains a surface relief pattern or a diffractive grating.

90. The multilayer article of claim 82, wherein the substrate is an optical article.

91. The multilayer article of claim 82, wherein the article is a polarizer, half wave plate, quarter wave plate, neutral density filter, birefringent plate, or diffractive optic.

92. The multilayer article of claim 82, wherein the adherent is cured utilizing thermal or radiation energy.

93. The multilayer article of claim 82, wherein the multilayer article has a Strehl value of 0.9 or greater.

94. A multilayer article comprising:
an article;
a first layer of at least partially cured adherent, wherein the first layer of adherent is disposed on a first surface of the article;
a second layer of at least partially cured adherent, wherein the second layer of adherent is disposed on a second surface of the article, and the multilayer article has a surface flatness of about 0.05 waves/cm to about 1 wave/cm at wavelengths of about 300 nanometers to 1600 nanometers and a transmission flatness of about 0.05 waves/cm to about 1 wave/cm at wavelengths of about 30 nanometers to 1600 nanometers.

95. The multilayer article of claim 94, wherein the article is a polarizer, half wave plate, quarter wave plate, neutral density filter, birefringent plate, or diffractive optic.

96. The multilayer article of claim 94, wherein the adherent is cured utilizing thermal or radiation energy.

97. The multilayer article of claim 94, wherein the multilayer article has a Strehl value of 0.9 or greater.
